(19) United States
(12) Patent Application Publication
(10) Pub. No.: US 2008/0114639 A1
(43) Pub. Date: May 15, 2008

(54) USER INTERACTION-BIASED ADVERTISING

(75) Inventors: Christopher A. Meek, Kirkland, WA (US); Jody D. Biggs, Redmond, WA (US); David M. Chickering, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/559,992

(22) Filed: Nov. 15, 2006

(51) Int. Cl. G06Q 30/00; G06F 17/40

(52) U.S. Cl. 705/10; 705/14

(57) ABSTRACT

On-line and/or off-line advertisement interactions are tracked for individual users. This information can then be utilized to adjust display parameters for an advertisement. Tracking can be accomplished via a client-side tracking mechanism and/or a server side tracking mechanism. The advertisement interactions allow advertisers to adjust their advertising campaigns to better target their advertisements. The tracked interactions can include, but are not limited to selections (clicking, etc.) and/or conversions (purchases) and the like. Some instances include a display component that can employ the user-specific interaction information to automatically adjust, for example, location, frequency, and/or to whom an advertisement is displayed. The interaction information can also be utilized for revenue generation by charging advertisers for the information and/or for adjusting their advertising campaigns and the like. Instances can be utilized with on-line and/or off-line advertising media.

### BACKGROUND

Advertising is typically a key revenue source in just about any commercial market setting. To reach as many consumers as possible, advertisements are traditionally presented via billboards, television, radio, and print media such as newspapers and magazines. However, with the widespread use of the Internet, advertisers have found a way to reach vast numbers of potential customers across a large and diverse geographic span. These types of advertisements can be seen on web pages or websites as well as in pop-up windows when a particular site is visited.

Generally, advertising space is not an unlimited resource. Thus, many businesses have resorted to participating in advertisement auctions. These auctions are utilized to sell advertising space based on “utility” to a bidder and/or based upon maximizing revenue to a seller. Utility or “value” to the bidder is not necessarily based on how much a bidder can afford to pay. A bidder may value the advertising space substantially but might not be able to afford to offer very much in monetary terms. Thus, utility is very important to determine how advertisers are chosen and/or how an advertisement is shown and to whom. Some measures of utility rely on whether a particular audience of the advertisement is interested in the advertising. This can be a difficult metric to determine because advertising interaction information for a targeted audience is not readily available to advertising systems and/or to advertisers.

### SUMMARY

User-specific interactions with advertisements are tracked to allow advertisers to adjust their advertising campaigns to better target their advertisements. A federated and/or centralized tracking system can be employed to allow optimal client/server information exchange. The interactions can include, but are not limited to, selections (clicking, etc.) and/or conversions (purchases) and the like, beyond simple user impression tracking. The interaction information can be utilized to determine the effectiveness of an advertising campaign so that the campaign can be adjusted accordingly. Some instances include a display component that can employ the user-specific interaction information to automatically adjust, for example, location, frequency, and/or to whom an advertisement is displayed. The interaction information can also be utilized for revenue generation by charging advertisers for the information and/or for adjusting their advertising campaigns and the like. Instances can be utilized with on-line and/or off-line advertising media.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an advertising interaction tracking system in accordance with an aspect of an embodiment.

FIG. 2 is another block diagram of an advertising interaction tracking system in accordance with an aspect of an embodiment.

FIG. 3 is a block diagram of an advertising interaction tracking system with federated tracking components in accordance with an aspect of an embodiment.

FIG. 4 is a block diagram of an advertising interaction tracking system with federated reporting components and a centralized tracking component in accordance with an aspect of an embodiment.

FIG. 5 is a block diagram of an advertising interaction tracking system with a display component in accordance with an aspect of an embodiment.

FIG. 6 is a flow diagram of a method of enhancing advertising in accordance with an aspect of an embodiment.

FIG. 7 is a flow diagram of a method of generating revenue through enhancing advertising in accordance with an aspect of an embodiment.

FIG. 8 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. “Computing systems” utilized herein refers to any device with computing capabilities such as, for example, laptop, desktop, mobile device (e.g., smart phones, etc.), and mainframe computing systems and the like.

Individual user interactions relating to an advertisement are tracked to facilitate in determining proper advertising parameters. These parameters can include, but are not limited to, monetary value, location, frequency, and/or target audience of an advertisement. The interaction information can be utilized by an advertising system to automatically adjust advertising parameters and/or utilized by an advertiser to augment adjustments to their advertising campaign. The advertising interactions can be tracked on-line and/or off-line to allow client-side and/or server-side tracking configurations and mechanisms.

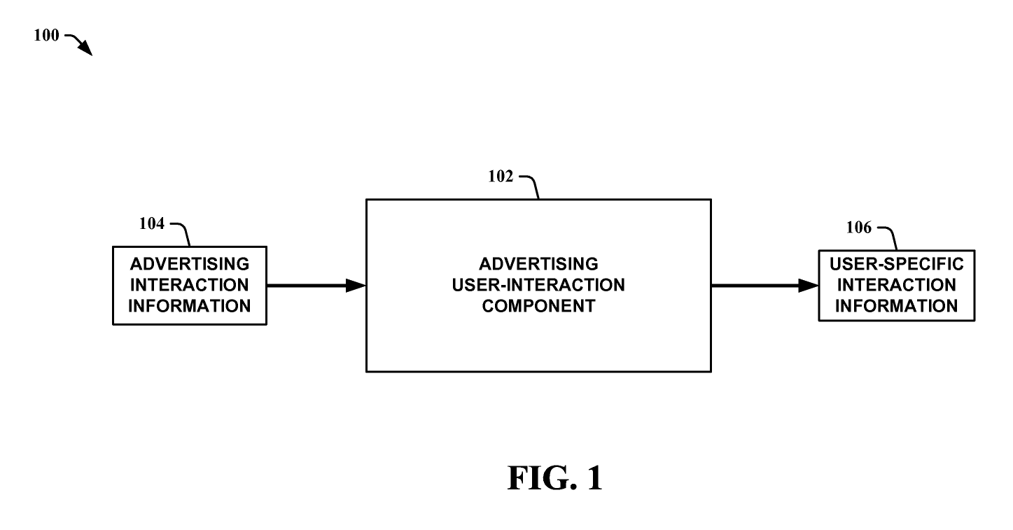

An advertising interaction tracking system 100 shown in FIG. 1 utilizes an advertising user-interaction component 102 that receives advertising interaction information 104 and provides user-specific interaction information 106. The advertising interaction information 104 can include, but is not limited to, specific user advertising interactions such as selections (e.g., clicking on an advertisement, etc.) and/or conversions (i.e., purchases based on an advertisement) and the like. The interactions do not include strictly simple impressions without having additional user involvement. Typically, the information 104 includes a form of user identification that can be utilized to track a particular user. This can include, for example, a globally unique identifier (GUID) and the like. The advertising user-interaction component 102 employs the advertising interaction information 104 to track individual users and associate their interactions with specific advertisements to provide the user-specific interaction information 106.

If unique user IDs are available, a particular user's interactions can be tracked regardless of where the user is when he interacts with an advertisement. Thus, as long as the ID can be determined, a user can be tracked while using different computing devices and/or in different locations and the like. The advertising user-interaction component 102 can receive the advertising interaction information 104 in real-time and/or in a delayed manner. Some instances provided herein can track a user's advertisement interactions off-line and then provide them to the advertising user-interaction component 102 when a user goes on-line again.

The user-specific interaction information 106 includes, but is not limited to, specific advertisement information such as location, size of the advertisement, time of day, duration of impression, frequency of the impression and/or targeting data and the like along with user interaction information for that specific advertisement. The user-specific interaction information 106 can then be utilized by an advertising system, for example, to automatically adjust advertisement parameters (e.g., new target audience, removal of advertisement, replacement of advertisement, extended duration, more frequent impressions, etc.) and/or by an advertiser to allow them to adjust their advertising campaign and the like. The user-specific interaction information 106 can also be utilized with advertising auction systems to allow for adjustments in bid price, advertiser bidding authorizations and/or advertising placement and the like.

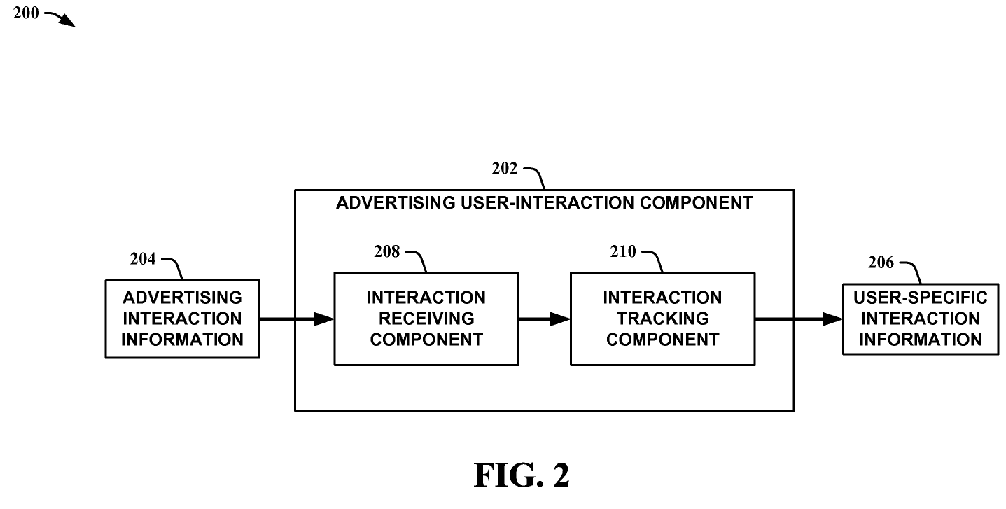

Another advertising interaction tracking system 200 is illustrated in FIG. 2 and employs an advertising user-interaction component 202 to obtain advertising interaction information 204 and provide user-specific interaction information 206. The advertising user-interaction component 202 utilizes an interaction receiving component 208 and an interaction tracking component 210. The interaction receiving component 208 obtains the advertising interaction information 204. This can be accomplished via direct input at a localized point of origin (e.g., input gathered at a user's computing device as they surf the web, etc.) and/or from a remote location to the point of origin (e.g., data gathered over the Internet, etc.).

The interaction tracking component 210 receives the advertising interaction information 204 from the interaction receiving component 208 and processes it to determine user-specific interaction information 206. This can include, but is not limited to, determining which users interacted with specific advertisements and/or advertisers and the like. Thus, the user-specific information 206 can indicate information relating to a specific advertisement and/or to a specific advertiser (e.g., a set of advertisements from a particular advertiser) and the like.

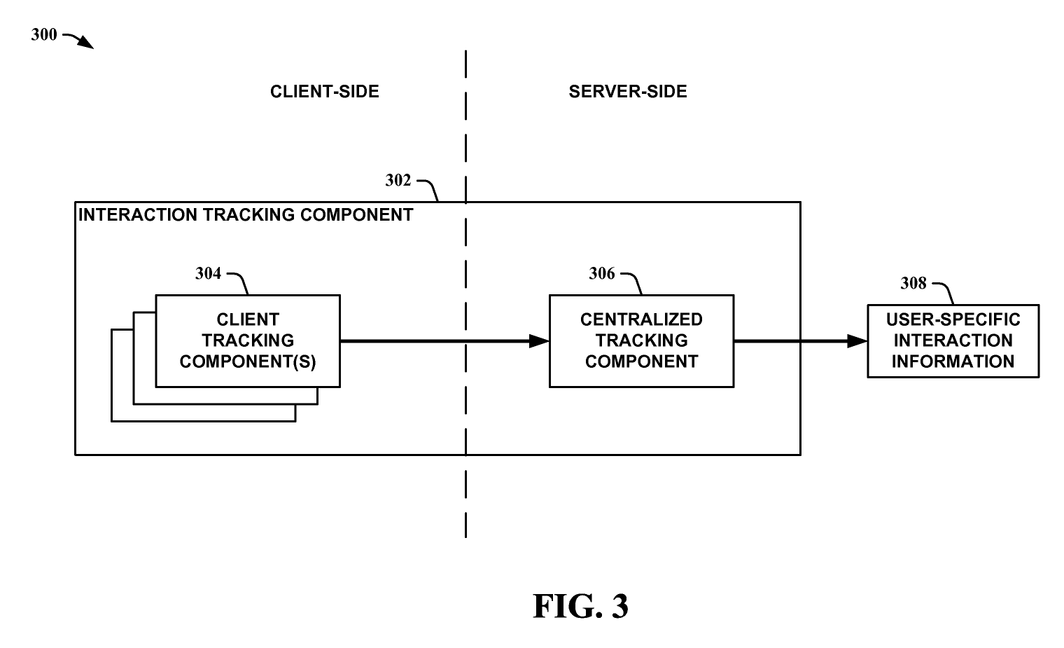

An advertising interaction tracking system 300 with federated tracking components 304, 306 is depicted in FIG. 3. In this illustration, the advertising interaction tracking system 300 utilizes an interaction tracking component 302 with components 304, 306 that reside on a client-side and a server-side. The client tracking component(s) 304 can reside on a single client computing device and/or multiple client computing devices. The client tracking component(s) 304 track user advertisement interactions and send the tracked interactions to the centralized tracking component 306.

Because each client tracking component(s) 304 can independently track a user's advertisement interactions, it is not necessary for the client tracking component(s) 304 to be in constant communication with the centralized tracking component 306. Thus, interaction information can be tracked off-line and sent to the centralized tracking component 306 when client-server communications are re-established. For example, a user can download a series of websites for off-line viewing. As the user interacts with advertisements found on the websites, this information is tracked utilizing the client tracking component(s) 304.

When the user logs back into the Internet (or other communication means), the client tracking component(s) 304 can upload tracking information to the centralized tracking component 306. By employing a centralized tracking component 306, a specific user can be tracked regardless of which computing device they are using when interacting with advertisements. So, a user can be tracked while using their mobile device, laptop, home desktop, and/or work computer and the like. The centralized tracking component 306 processes the tracking information and provides composite user-specific interaction information 308 for utilization with advertising systems and/or for dissemination to advertisers and the like.

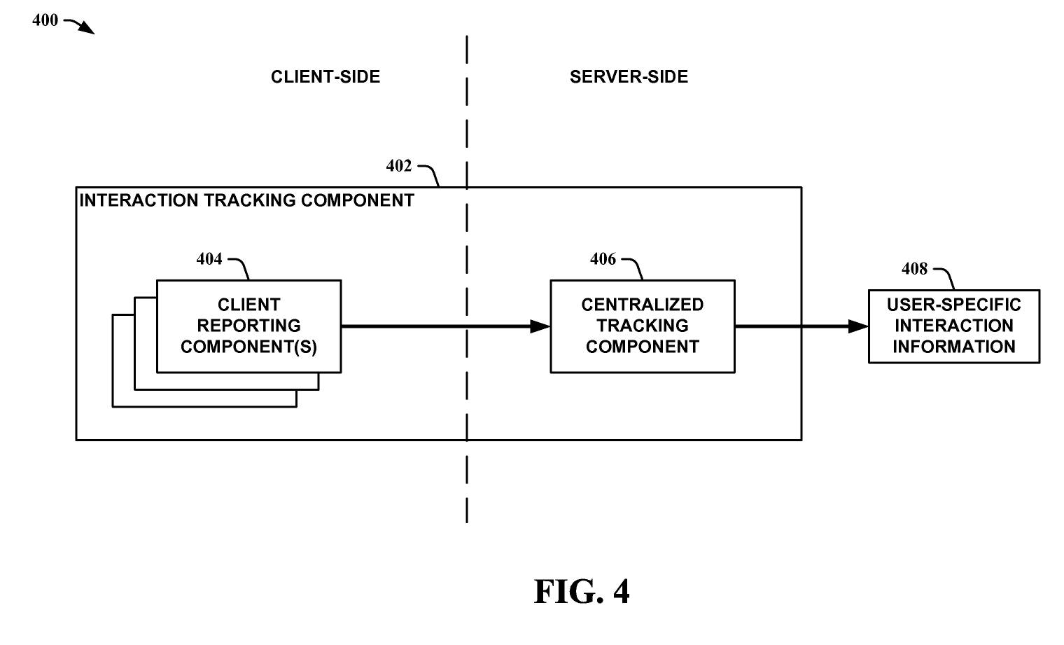

In another instance shown in FIG. 4, an advertising interaction tracking system 400 employs an interaction tracking component 402 utilizing federated reporting components 404 and a centralized tracking component 406. In this example, client reporting component(s) 404 reside on one or more client computing systems and report to the centralized tracking component 406. The client reporting component(s) 404 typically send user advertising interaction information to the centralized tracking component 406 as it occurs. Thus, when a user interacts with an advertisement, the client reporting component(s) 404 sends out this information to the centralized tracking component 406. Typically, this requires that the client reporting component(s) 404 and the centralized tracking component 406 are in substantially constant communication with each other. Since the client reporting component 404 does not track the user interactions but simply reports the raw information to the centralized tracking component 406, it can be much smaller in size and use less system resources.

It can be appreciated that the prior two examples, use federated components to produce an advertising interaction tracking system. Other instances can employ a mix of the above described systems and/or an integrated structure such that a single centralized tracking component can be employed that utilizes tracking information gathered via the server-side. Thus, when a user interacts with on-line advertisements, the websites hosting these advertisements can report the activity directly to the interaction tracking component (e.g., advertising system) and/or to an advertiser who then provides it to the interactive tracking component.

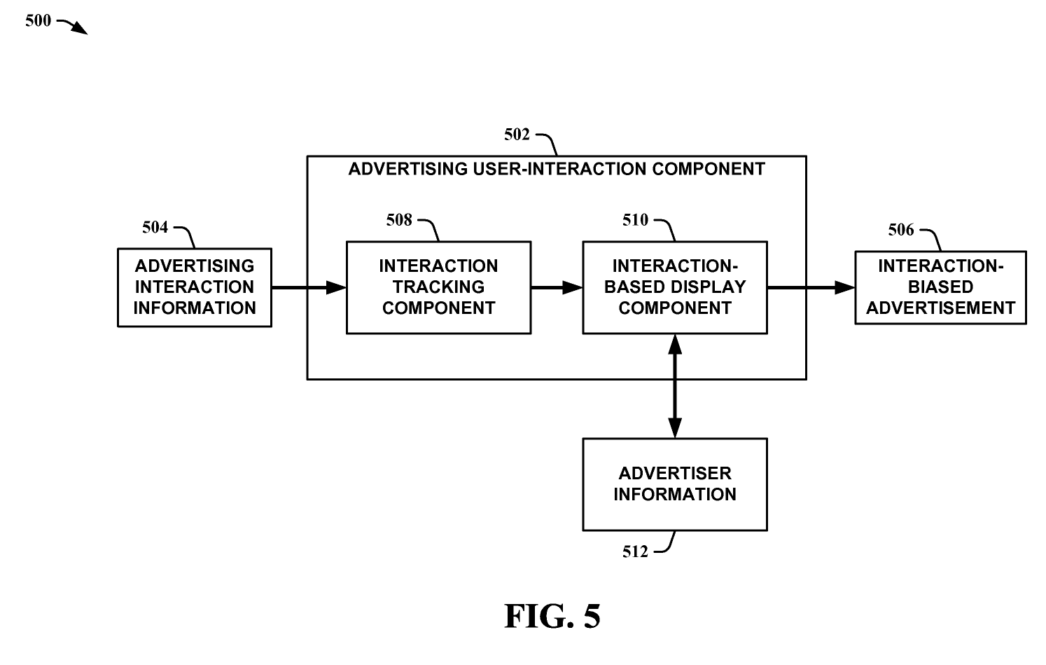

An advertising interaction tracking system 500 shown in FIG. 5 utilizes an advertising user-interaction component 502 that includes an interaction-based display component 510. This enables the advertising interaction system 500 to account for user interactions when displaying advertisements. The interaction tracking component 508 obtains advertising interaction information 504 and provides tracked information to the interaction-based display component 510. The interaction-based display component 510 can also incorporate advertiser information 512 along with the tracked information to provide interaction-biased advertisement 506. In other instances, the advertiser information 512 can be sent to the interaction tracking component 508 and then provided to the interaction-based display component 510. The advertiser information 512 can include, but is not limited to, advertiser preferences, conversion information for particular users, bid amounts based on advertising interaction information 504, and/or advertisement placement parameters based on advertising interaction information 504 and the like. The interaction-based display component 510 can automatically (this can be a continuous process and/or it can be based upon certain thresholds of user interaction being reached, etc.) provide the interaction-biased advertisement 506 and/or it can provide it when prompted by an advertiser and/or advertising system and the like.

Because on-line and off-line electronic advertising is growing and is becoming more important as people spend more time using computers/software, the instances provided herein are extremely valuable to advertising systems and advertisers as services and software are being increasingly funded via advertising. By utilizing these instances, the value of advertising systems to advertisers is increased substantially by allowing them to target advertisements to previous customers. Today, most electronic advertising is done in a connected scenario (e.g., via a web-browser, instant messenger client, etc.), but in the future, there will be advertisements in software systems that are only occasionally connected to a network such as the Internet. Examples of advertisements include graphical and text advertisements on web pages and text advertisements on search results pages and the like and the types of media include, but are not limited to, video advertising, paid-search advertisements, graphical advertisements, contextual advertisements, and/or animated advertisements and the like.

Current on-line advertising systems only allow advertisers to target advertisements to customers as a function of features of the customer such as, for example, demographic features—age, gender and location and some types of behaviors (e.g., sports enthusiast). While these features are valuable, it is often more valuable to know that the customer is, for example, a previous customer and/or has shown prior interest in a particular advertisement and the like. Current on-line advertising systems do not allow advertisers to target advertisements as a function of the customer's previous interactions (i.e., involvement with advertising beyond merely a simple impressions) with advertisers and/or advertisements. Allowing the advertisers to do such targeting brings substantial value to the advertisers. Examples of valued customer information include—Has the customer clicked on an advertisement for the company? How many times? Has the customer converted (e.g., purchased a product from the company)? How many times?

To determine these types of information, instances provided herein can include a tracking component and/or a display component. There are a variety of potential implementations for a tracking component. For instance, the information can be stored on a server and/or on a client. In one implementation using a client, a user is given a unique identifier (GUID) which is stored on their computer. This GUID is accessed by a server when an advertisement is shown or clicked by a consumer, and this information is then logged in a cookie on the client. In a system in which users are occasionally off-line the logging can either be done on the client and/or selection information can be uploaded to a server when the off-line system connects to the network/internet.

Both of these are easy to track in an on-line advertising system as current payment systems for advertising are based on impressions for display advertisements and selections for search advertising. In addition, neither requires the advertiser to change their current behavior. To track purchases, an advertiser needs to enable conversion tracking. This is typically done by adding a “clear gif” on a post-conversion page (i.e., providing a web beacon mechanism). The “clear gif” refers to the advertising system's domain which allows the advertising system to access a cookie containing a GUID for the user. This type of tracking is currently provided by on-line advertising systems.

Advertisers also might want to change the appearance and display characteristics of their advertisements as a function of the information described above. Example of changes can include, but are not limited to,
Guaranteeing a particular spot (e.g., the top position) in a listing of advertisements. If there is more than one advertiser with a “returning customer” then the position could be chosen via a lottery. In a search advertising system, the advertiser might be charged the going rate for the top position.
Provide preferential treatment to the advertisement (e.g., preempt other advertisements from being shown in a display advertisement system).
Alter the copy and/or graphics associated with the advertisement.
Allow the advertiser to change their bid in an auction for the impression as a function of this information.
The advertiser is charged a flat rate for using the customer information or is charged a flat-rate for each use of the information.
   In addition to allowing advertisers to bid on the behavior of a consumer with respect to the advertisers' advertisements, website, etc . . . the advertiser could bid on the basis of the behavior of the consumer on particular other sites/advertisements such as competitors.

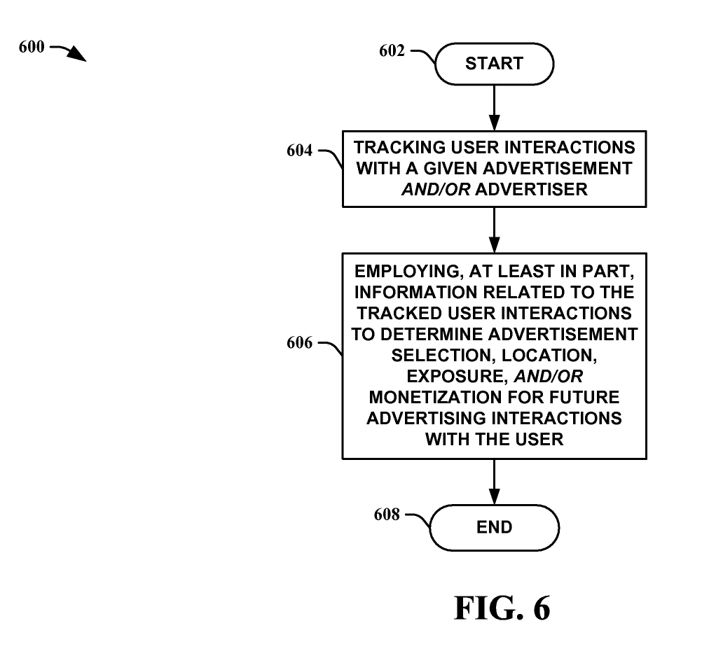

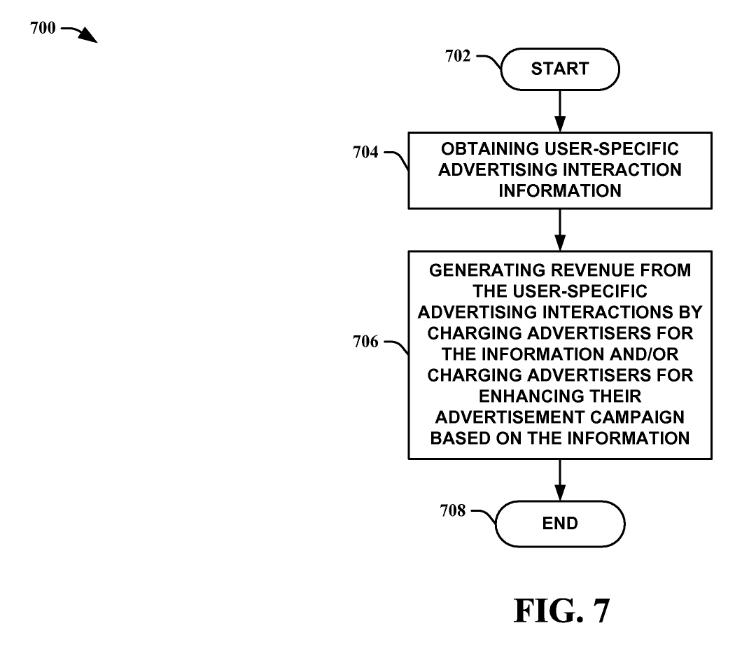

In view of the exemplary systems shown and described above, methodologies that may be implemented in accordance with the embodiments will be better appreciated with reference to the flow charts of FIGS. 6 and 7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 6, a flow diagram of a method 600 of enhancing advertising in accordance with an aspect of an embodiment is shown. The method 600 starts 602 by tracking user interactions with a given advertisement and/or advertiser 604. The interactions can be tracked from a server-side and/or a client-side tracking mechanism. The interactions include user involvement with advertising beyond merely witnessing and/or possible exposure to an impression. Thus, tracking information can be stored locally and sent to a centralized server mechanism (e.g., for storage/use on a server) when convenient and/or when communications are permitted between client and server. Raw interaction information can also be sent substantially real-time to a server mechanism for tracking purposes as well.

Information related to the tracked user interactions is then employed, at least in part, to determine advertisement selection, location, exposure, and/or monetization for future advertising interactions with the user 606, ending the flow 608. The tracked user interactions with an advertisement can be employed to directly and/or indirectly influence parameters associated with placement of an advertisement and/or with present and/or future revenue associated with that advertisement and the like. For example, advertisers can be selected and/or charged a premium based on their degree of interaction with a current user and the like. Conversion information can also be obtained from, for example, advertisers and the like to facilitate in determining advertising parameters.

Turning to FIG. 7, a flow diagram of a method 700 of generating revenue through enhancing advertising in accordance with an aspect of an embodiment is illustrated. The method 700 starts 702 by obtaining user-specific advertising interaction information 704. The user-specific advertising interaction information can be obtained from a server-side and/or a client-side tracking mechanism. Revenue is then generated from the user-specific advertising interactions by charging advertisers for the information and/or charging advertisers for enhancing their advertisement campaign based on the information 706, ending the flow 708. Tracked user interaction information is extremely valuable to an advertiser because it indicates the effectiveness of the advertisers advertising campaign on targeted users. This information can substantially reduce the costs of a campaign and dramatically increase its effectiveness at the same time.

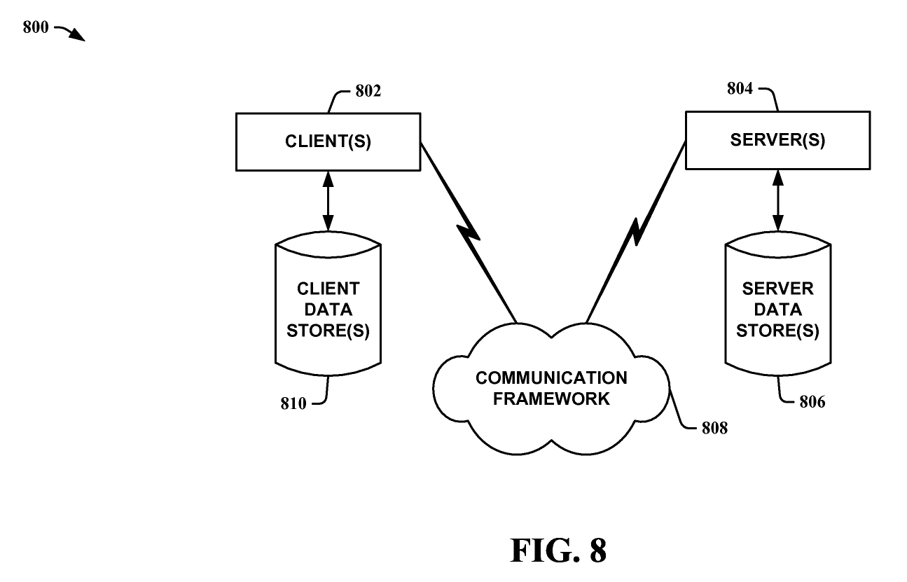

FIG. 8 is a block diagram of a sample computing environment 800 with which embodiments can interact. The system 800 further illustrates a system that includes one or more client(s) 802. The client(s) 802 can be hardware and/or software (e.g., threads, processes, computing devices). The system 800 also includes one or more server(s) 804. The server(s) 804 can also be hardware and/or software (e.g., threads, processes, computing devices). One possible communication between a client 802 and a server 804 can be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in user-interaction biased advertisement facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that tracks advertisement interactions, comprising:
an interaction receiving component that receives user interaction information relating to an advertisement; and
an interaction tracking component that tracks the user-specific interactions with the advertisement and allows an advertiser to adjust their advertising campaign as a function of the tracked interactions.

2. The system of claim 1, the user interaction information comprising information relating to conversions and/or selections associated with an advertisement.

3. The system of claim 1, the adjustment to the advertising campaign comprising changing a copy and/or presentation, position, and/or bid associated with the advertisement.

4. An advertising system that employs the system of claim 1 in search, contextual, and/or display advertising.

5. An off-line advertising system that employs the system of claim 1.

6. An on-line gaming system that employs the system of claim 1 to determine advertising within a game.

7. The system of claim 1 further comprising:
at least one client tracking component that resides on a client-side device and communicates tracked user-specific interactions with at least one advertisement; and
a centralized tracking component that resides on a server-side device and receives the tracked user-specific interactions for the advertisement from at least one client tracking component.

8. The system of claim 7, the centralized tracking component obtains tracked user-specific interactions when the client tracking component establishes Internet communications.

9. The system of claim 1 further comprising:
at least one client reporting component that resides on a client-side device and reports advertisement interactions; and
a centralized tracking component that resides on a server-side device and receives the reported advertisement interactions and tracks this information based on a specific user.

10. The system of claim 1 further comprising:
an interaction-based display component that displays advertisements based on a function of the tracked interactions to adjust an advertiser's advertising campaign.

11. A method for enhancing advertising, comprising:
tracking user interactions with a given advertisement and/or advertiser; and
employing, at least in part, information related to the tracked user interactions to determine advertisement selection, location, exposure, and/or monetization for future advertising interactions with the user.

12. The method of claim 11 further comprising:
storing the tracked user interactions on a server and/or client.

13. The method of claim 11 further comprising:
selecting advertisers for an advertising location based on an advertiser's degree of interaction with a current user.

14. The method of claim 11 further comprising:
generating revenue by charging advertisers for information associated with the tracked user interactions.

15. The method of claim 11 further comprising:
utilizing conversion information obtained from advertisers for a user as part of the tracked user interactions.

16. A system that tracks advertisement interactions, comprising:
means for obtaining user selection and/or conversion information for a specific advertisement; and
means for tracking the information for a specific user and advertisement to allow augmentation of displaying of the advertisement.

17. The system of claim 16 further comprising:
means for displaying the augmented advertisement based on the tracking information.

18. A computer readable medium having stored thereon computer executable components of the system of claim 1.

19. A device employing the method of claim 11 comprising at least one selected from the group consisting of a computer, a server, and a handheld electronic device.

20. A device employing the system of claim 1 comprising at least one selected from the group consisting of a computer, a server, and a handheld electronic device.
